(19) United States
(12) Patent Application Publication
(10) Pub. No.: US 2007/0013163 A1
(43) Pub. Date: Jan. 18, 2007

(54) Motorcycle spreader clamp

(76) Inventor: Vincenzo Costa, Huntington Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 11/144,101

(22) Filed: Jun. 3, 2005

(51) Int. Cl. B62K 1/00

(52) U.S. Cl. 280/280

(57) ABSTRACT

A motorcycle spreader clamp has a leg opening for holding a fork leg and a pinch arm defined by a pinch slot that starts from the leg opening and travels to a pinch arm outside face. A bolt opening on the pinch arm outside face has a machined bore within the bolt opening. The machined bore has a pinch thread machined to receive a pinch bolt. Spreader thread is machined to receive a spreader bolt, so that a user may use a spreader bolt to enlarge the leg opening, then install a fork leg, and then use a pinch bolt to secure the fork leg to the leg opening.

### DISCUSSION OF RELATED ART

Motorcycles have a fork tree assembly connecting the frame to fork legs holding a steering axle. Fork trees, also known as a triple clamps on motorcycles, have been used in a wide variety of two wheeled vehicles including bicycles as seen in U.S. Pat. No. 5,257,553 granted to Cheng the disclosure of which is incorporated herein by reference. Dual piston rods are held in the front fork assembly as seen in U.S. Pat. No. 5,829,773 to Rajaee the disclosure of which is incorporated herein by reference. By reference to prior art, current fork trees are called triple clamps because they hold a pair of motorcycle suspensions in two clamping locations while holding the frame of the motorcycle in the third clamping location. The fork tree comprises an upper clamping tree member, and a lower clamping tree member.

Prior art motorcycle fork trees such as the type patented in U.S. Pat. No. 4,565,384 granted to Dehnisch describes the typical assembly, the disclosure of which is incorporated herein by reference.
“A motorcycle fork tree assembly includes a steering axle attached to a top tree piece and a bottom inner tree piece. The bottom inner tree piece is pivotally secured to a bottom intermediate tree piece which is adjustably positioned within a bottom outer tree piece. The fork tubes extend through the bottom outer tree piece and are attached to the top tree piece via plugs having offset bores positioned in one of a number of threaded holes of the top tree piece. The degree of trail of the steering assembly for the motorcycle can be easily and quickly adjusted by the independent adjustment of one or more of the bottom outer tree piece relative to the bottom inner tree piece or the plugs in the top tree piece.”

Typically, custom motorcycle parts are shipped to a motorcycle shop for construction. The front suspension comprising the fork legs held by the triple clamp traditionally requires assembly by cutting the legs to length and inserting them into the openings of the triple clamp. The parts are commonly formed of aluminum having a chromed surface. The triple clamp openings have a very tight tolerance. Thus, chrome surfaces are sometimes scratched during fitting. Because the suspension legs and the triple clamp both have chrome surfaces that are secured to each other, there is a risk of scratching during assembly. Because custom motorcycles are considered to be works of art, even small scratches on chrome can be a problem.

### BRIEF DESCRIPTION OF THE DRAWINGS

FIG. 1 shows an exploded view of the present invention.

FIG. 2 shows a top view of the present invention.

FIG. 3 shows a perspective view of the present invention.

FIG. 4 is a diagram of the pinch bolt.

FIG. 5 is a diagram of the spreader bolt.

### DETAILED DESCRIPTION OF THE PREFERRED EMBODIMENT

The following list is a call out list of elements allowing easy reference to the drawings.
108 Pinch Slot
110 Right Fork Leg
111 Left Fork Leg
120 Triple Clamp
131 Left Leg Opening
132 Right Leg Opening
140 Frame Member
141 Cover For Frame Connection Opening
142 Frame Connection Opening
150 Right Pinch Bolt
151 Left Pinch Bolt
160 Miscellaneous Decorative Design
120 Pinch Thread
120 Spreader Thread
310 Planar Top Face
320 Pinch Arm Outside Face
325 Bolt Bore
330 Radius Groove
340 Pinch Arm Inside Face
350 Bolt Opening
410 Pinch Bolt
420 Pinch Bolt Thread
430 Pinch Bolt Shaft
440 Pinched Pinch Arm
510 Spreader Bolt
520 Spreader Bolt Thread
530 Spreader Bolt Shaft
540 Spreading Pinch Arm

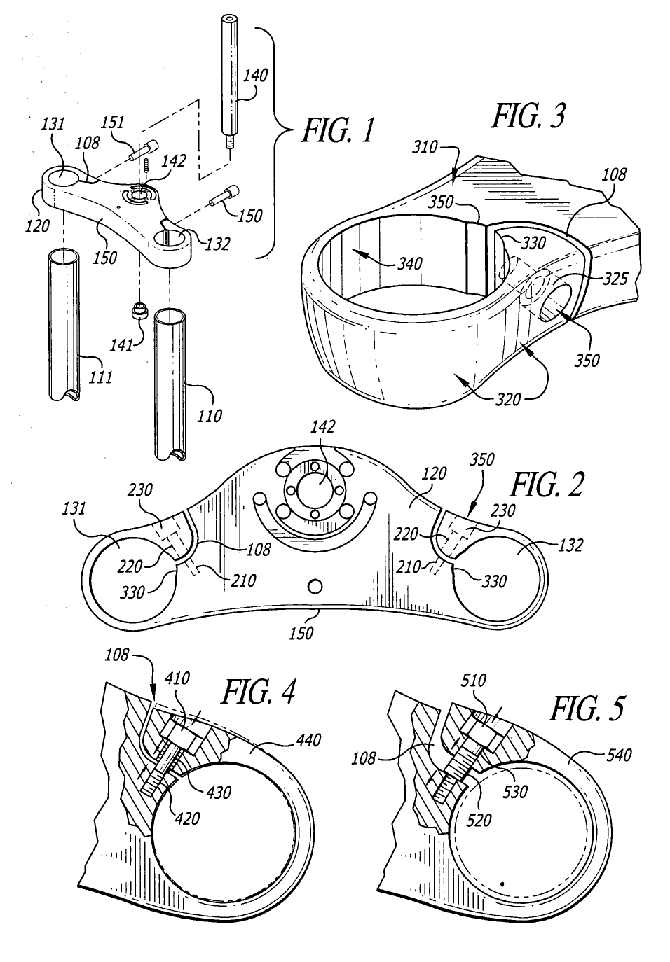

The object of the invention is to decrease the risk of scratched chrome when suspension legs 111, 110 are inserted through the opening of the lower triple clamp 120 to be connected to the upper triple clamp and then the lower triple clamp. However, the same clamp structure can be used to clamp a wide variety of articles such as an axle, wire bundles, and fender blades, which are not necessarily cylindrical. FIG. 1 shows an exploded view of the present invention providing environmental context. Typically, a motorcycle suspension has a pair of triple clamps including an upper clamp and a lower clamp. The detailed description of the preferred embodiment discusses the lower clamp embodiment, but the invention can be applied for the upper clamp embodiment as well. Both the upper and lower triple clamps have generally planar configuration.

The triple clamp 120 shown has a left leg opening 131 and a right leg opening 132. The left leg opening holds left fork leg 111 and the right leg opening holds right fork leg 110. The left and right leg openings receive the fork legs snugly. The triple clamp 120 has a pair of pinch arms having a shaped profile defined by a pair of pinch slots 108. The pinch slot 108 formed in the triple clamp 120 allows opening of the left and right openings to receive the legs. A pair of retaining bolts shown has the left pinch bolt 151 and the right pinch bolt 150 pinch the arms of the triple clamp to retain the legs. The frame 140 attaches to the midpoint of the triple clamp 120. Frame cover 141 caps the frame attachment opening 142. Optionally, miscellaneous ornamental elements 160 can be machined from the body of the triple clamp.

FIG. 2 shows a top view of the present invention. Here, the ornamental elements 160 are minimized and the frame connection opening 142 appears circular. The left leg opening 131, and right leg opening 132 are circular for receiving a cylindrical leg member such as the left or right leg.

The left leg opening 131, and right leg opening 132 include a radius groove 330 having a smaller radius than the left leg opening 131, and the right leg opening 132. The radius groove is formed at the inside end of the pinch slot 108. The groove can also be made in other shapes, such as a bevel. The groove can be formed by cutting, sanding or otherwise wearing the corner formed between the left leg opening and the pinch slot 108. When the groove does not have a circular or arc shaped profile characteristic of objects that have radii, the groove can be more simply called a groove instead of a radius groove.

FIG. 3 shows a perspective view of the present invention triple clamp also called a fork tree. The top planar face 310 of the device is seen at an angle suggesting that it is about perpendicular to the pinch arm outside face 320. The pinch arm outside face 320 has a pinch slot 108 cut into it at about perpendicular angle as well as any bolt opening 350 also cut in the pinch arm outside face 320. The pinch slot 108 curves from an angle about perpendicular to the pinch arm inside face 340, groove 330 and leg opening 131, 132 to an angle about perpendicular to the outside face of the pinch arm 320.

This forms an area on the pinch arm allowing machining of the bolt opening 350. Machining a bolt bore 325 forms a machined bolt opening 350, on the pinch arm outside face 320. A spreader thread 220 is machined to receive a spreader bolt. A pinch thread 210 is machined to receive a pinch bolt. A single bolt opening 350 for each leg typically requires a pair of bolt openings 350 for a pair of legs 110, 111. The bolt opening 350 is preferably smooth. The spreader thread 220 has a smaller diameter than the bolt opening forming a shelf between the spreader thread and the bolt opening. Pinch thread preferably has a smaller cross-section than the spreader thread.

FIG. 3 shows the slot 108 when it begins at the pinch arm inside face 340, is about parallel to the slot 108 when it terminates at the pinch arm outside face 320. Preferably, the slot 108 when it begins at the pinch arm inside face 340, is about perpendicular to the spreader thread 220, the pinch thread 210 and the bolt bore 325 allowing the spreader bolt bottom to abut the bottom surface of the coplanar slot 108 when it begins at the pinch arm inside face 340.

FIG. 5 shows a cross section of the bolt area. The spreader bolt 510 spreading the pinch arm 540 increases the size of the pinch slot 108, which is exaggerated in FIG. 5 for emphasis. The bottom of the spreader bolt preferably abuts the bottom surface of the pinch slot at an about coplanar configuration providing force to open the spreading pinch arm 540. The pinch thread 210 has a smaller cross-section than the spreader bolt preventing the spreader bolt from engaging with the pinch thread 210.

The spreader thread 220 engages only with the threaded engagement portion 520 of the spreader bolt 510 and optionally, the spreader bolt has a smooth bore area 530 that does not engage the spreader thread 220.

FIG. 4 shows a cross section of the bolt area having a pinched pinch arm 440. The pinch slot 108 is compressed as exaggerated in FIG. 4 for emphasis. The pinch bolt 410 has a smaller cross section than the spreader thread 220 allowing a non-engagement portion 430 of the pinch bolt 410 to pass through the spreader thread 220 without engagement. The non-engagement portion 430 is preferably not threaded and smooth however it can also be threaded. The threaded engagement portion 420 of the pinch bolt 410 engages with the pinch thread 210.

The foregoing describes the preferred embodiments of the invention. Modifications may be made without departing from the spirit and scope of the invention as set forth in the following claims. The present invention is not limited to the embodiments described above, but encompasses any and all embodiments within the scope of the following claims.

1. A motorcycle spreader clamp comprising:
a leg opening for holding a fork leg;
a pinch arm defined by a pinch slot that starts from the leg opening and travels to a pinch arm outside face;
a bolt opening on the pinch arm outside face;
a machined bore within the bolt opening, the machined bore having pinch thread machined to receive a pinch bolt, and spreader thread machined to receive a spreader bolt, whereby a user may use a spreader bolt to enlarge the leg opening, then install a fork leg, and then use a pinch bolt to secure the fork leg to the leg opening.

2. The motorcycle spreader clamp of claim 1 wherein the spreader thread is of a smaller diameter than the bolt opening forming a shelf between the spreader thread and the bolt opening.

3. The motorcycle spreader clamp of claim 1 further comprising a radius groove formed at a pinch slot location of the leg opening, wherein the leg opening is circular having a first radius and the radius groove having a second radius smaller than the first radius.

4. The motorcycle spreader clamp of claim 1 further comprising a groove formed at a pinch slot location of the leg opening, wherein the groove is formed by wearing the corner at the leg opening and the pinch slot.

5. The motorcycle spreader clamp of claim 1 wherein the pinch slot curves from an angle about perpendicular to a pinch arm inside face, to an angle about perpendicular to an outside face of the pinch arm.

6. The motorcycle spreader clamp of claim 1 wherein the pinch slot begins at a pinch arm inside face about perpendicular to both the spreader thread and the pinch thread.

7. The motorcycle spreader clamp of claim 1 wherein pinch thread has a smaller cross-section than the spreader thread.

8. A motorcycle triple clamp comprising:
a pair of leg openings for holding a pair of fork legs;
a pair of pinch arms defined by a pair of pinch slots that start from each leg opening and travels to each pinch arm outside face;
a pair of bolt openings on each pinch arm outside face;
a pair of machined bores within each bolt opening, each machined bore having pinch thread machined to receive a pinch bolt, and spreader thread machined to receive a spreader bolt, whereby a user may use spreader bolts to enlarge leg openings, then install fork legs, and then use pinch bolts to secure the fork legs to the leg openings.

9. The motorcycle triple clamp of claim 8 wherein each spreader thread is of a smaller diameter than each bolt opening forming a shelf between each spreader thread and each bolt opening.

10. The motorcycle triple clamp of claim 8 further comprising radius grooves formed at a pinch slot location of each leg opening, wherein each leg opening is circular having a first radius and each radius groove having a second radius smaller than the first radius.

11. The motorcycle triple clamp of claim 8 further comprising grooves formed at each pinch slot location of each leg opening, wherein each groove is formed by wearing each corner at each leg opening and each pinch slot.

12. The motorcycle triple clamp of claim 8 wherein each pinch slot curves from an angle about perpendicular to a pinch arm inside face, to an angle about perpendicular to an outside face of the pinch arm.

13. The motorcycle triple clamp of claim 8 wherein both pinch slots curve from an angle about perpendicular to each pinch arm inside face, to an angle about perpendicular to each outside face of each pinch arm, wherein each bottom of each spreader bolt abuts each bottom of each pinch slot when providing force to spread the pinch arms.

14. A motorcycle lower triple clamp comprising:
top planar face;
a pair of leg openings;
a pair of pinch arms defined by a pair of pinch slots that start from each leg opening and travels to each pinch arm outside face;
a pair of circular bolt openings on each pinch arm outside face;
a pair of machined bores within each bolt opening, each machined bore having pinch thread machined to receive a pinch bolt, and spreader thread machined to receive a spreader bolt, whereby a user may use spreader bolts to enlarge leg openings, then install fork legs, and then use pinch bolts to secure the fork legs to the leg openings.

15. The motorcycle triple clamp of claim 14 wherein each spreader thread is of a smaller diameter than each bolt opening forming a shelf between each spreader thread and each bolt opening.

16. The motorcycle triple clamp of claim 14 further comprising radius grooves formed at a pinch slot location of each leg opening, wherein each leg opening is circular having a first radius and each radius groove having a second radius smaller than the first radius.

17. The motorcycle triple clamp of claim 14 wherein each pinch slot curves from an angle about perpendicular to a pinch arm inside face, to an angle about perpendicular to an outside face of the pinch arm.

18. A spreader clamp comprising:
a leg opening for holding an article;
a pinch arm defined by a pinch slot that starts from the opening and travels to a pinch arm outside face;
a bolt opening on the pinch arm outside face;
a machined bore within the bolt opening, the machined bore having pinch thread machined to receive a pinch bolt, and spreader thread machined to receive a spreader bolt, whereby a user may use a spreader bolt to enlarge the opening, then install the article, and then use a pinch bolt to secure the fork leg to the opening.

19. The spreader clamp of claim 18 wherein the spreader thread is of a smaller diameter than the bolt opening forming a shelf between the spreader thread and the bolt opening.

20. The spreader clamp of claim 18 further comprising a radius groove formed at a pinch slot location of the leg opening, wherein the opening is circular having a first radius and the radius groove having a second radius smaller than the first radius.

21. The spreader clamp of claim 18 further comprising a groove formed at a pinch slot location of the leg opening, wherein the groove is formed by wearing the corner at the leg opening and the pinch slot.

22. The spreader clamp of claim 18 wherein the pinch slot curves from an angle about perpendicular to a pinch arm inside face, to an angle about perpendicular to an outside face of the pinch arm.

23. The spreader clamp of claim 18 wherein the pinch slot begins at a pinch arm inside face about perpendicular to both the spreader thread and the pinch thread.
